(19) United States
(12) Patent Application Publication
(10) Pub. No.: US 2020/0260824 A1
(43) Pub. Date: Aug. 20, 2020

(54) SYSTEM HAVING LOCKING MECHANISM WITH MULTIPLE STAGE LOCKING VERIFICATION

(71) Applicant: CONTROL DYNAMICS, INC., EVERETT, WA (US)

(72) Inventor: ERIC M. MORAN, CAMANO ISLAND, WA (US)

(21) Appl. No.: 16/869,111

(22) Filed: May 7, 2020

Related U.S. Application Data
(63) Continuation-in-part of application No. 16/211,758, filed on Dec. 6, 2018, now Pat. No. 10,667,583.
Application No. 16/211,758 is a continuation-in-part of application No. 15/065,582, filed on Mar. 9, 2016, now Pat. No. 10,238,184.
(60) Provisional application No. 62/186,557, filed on Jun. 30, 2015.

(51) Int. Cl. A44B 11/25; A44B 11/26; A44B 17/00

(52) U.S. Cl. CPC A44B 11/2519; A44B 11/253; A44B 11/2561; A44B 11/2573; A62B 35/0025; A44B 11/266; A44B 17/0005; A44B 17/0041; A44B 11/263

(57) ABSTRACT

A system and method for a locking mechanism that includes an ability to indicate that a fall event has occurred as well as indicate proper engagement via a signal cable coupled through a harness. The locking mechanism includes a mechanical indicator that is disposed within the locking mechanism (as opposed to far away from the locking mechanism at a remote cable attachment point) that can visually indicate that a fall event has occurred. Further, the locking mechanism includes electronic components including three magnetic actuators and corresponding electronic switches that signal change of state. Locking tabs and a leading edge of the insert respectively include the three magnetic actuators. The electronic switches, which may be magnetically activated reed switches, signal status change to an external controller and, optionally, an external computer.

### PRIORITY CLAIM TO RELATED APPLICATIONS

The present application claims priority and benefit from U.S. patent application Ser. No. 16/211,758, filed Dec. 6, 2018 and titled, “LOCKING MECHANISM WITH ONE AND TWO-STAGE LOCKING VERIFICATION” which in turn claims priority and benefit from U.S. patent application Ser. No. 15/065,582, filed Mar. 9, 2016 and titled, “LOCKING MECHANISM WITH ONE AND TWO-STAGE LOCKING VERIFICATION” which, in turn, claims priority and benefit from U.S. provisional patent application Ser. No. 62/186,557, filed on Jun. 30, 2015, and titled and titled, “LOCKING MECHANISM WITH ONE AND TWO-STAGE LOCKING VERIFICATION”. The entire content of the parent application and the provisional application is herein expressly incorporated by reference.

### TECHNICAL FIELD

The subject matter pertains to locking mechanisms that have one and two-stage locking verification capabilities through mechanical and electro-mechanical means with two and three point unlocking means.

### BACKGROUND

A need exists for an improved locking mechanism, particularly with a two-stage locking verification for dangerous applications such as releasing a worker strapped into a safety harness from a lifeline. Current known connectors can easily be bypassed.

### SUMMARY

The subject matter is directed to an improved locking mechanism for use in a fall-protection safety system. In embodiments, the locking mechanism includes a visual mechanical indictor having a visually striking color (e.g., red) that is exposed when a fall event happens (if the fall event exceeds a threshold force that trips or breaks load pins holding the indicator in a non-indicating position. In this manner, the visual indicator is located within the locking device that is situated near the worker such that the worker may quickly decipher that a previous fall event has happened and that the system will require inspection and recertification prior to next use. This is, an improvement from systems that have an indicator disposed at a ceiling mount far away from the worker.

The locking mechanism further includes a mechanical (one stage) and electro/mechanical (two stage) locking verification. Further, among various embodiments, two and three point unlocking means are included.

The mechanical aspects include a receiver base, a pair of locking tabs, and an insert. Each locking tab has a first arm and a second arm where each arm is connected at a pivot point. Each locking tab is configured to pivot about the pivot point that is operatively connected to an upper portion of the receiver base in a spaced apart fashion to form a cavity between the receiver base and the locking tabs.

A lower portion of the receiver base is configured to be operably engageable with a first device. A lower portion of the insert is configured to be received within a cavity and retained by at least the first arms of the locking tabs. An upper portion of the insert is configured to be operably engageable with a second device. The lower portion of the insert is retained by the receiver base and locking tabs. To disengage, both locking tabs must be rotated to dislodge the insert. Such disengagement is the two point mechanical unlocking method.

Another aspect includes a push button assembly that has a retractable lip that is configured to engage with the receiver base and retains the second arms from the locking tabs from movement. Here, the push button would need to be depressed and retract the lip from the receiver base and from the two second arms at the same time a force is applied to the locking tabs to rotate the arms of each locking tab to disengage the insert from the cavity. Such disengagement described herein is the three point mechanical unlocking method.

The subject matter may further include electronic components including three magnetic actuators and corresponding electronic switches that signal change of state. The two second arms of the locking tabs and a leading edge of the insert respectively include the three magnetic actuators. The electronic switches, which may be magnetically activated reed switches, signal status change to an external controller and, optionally, an external computer. Further, status signals and power signals may be routed through a steel cable or woven nylon harness that coupled the locking mechanism to a local anchor point. Change of status notification may be important on critical safety worksites where lack of mechanical and electronic connection can be life threatening.

These and other advantages will become more apparent upon review of the Drawings, the Detailed Description, and the Claims.

### BRIEF DESCRIPTION OF THE DRAWINGS

Like reference numerals are used to designate like parts throughout the several view of the drawings, wherein:

FIG. 1 is a front perspective view of an assembled locking mechanism disclosing a receiver base, a pair of pivotable locking tabs about respective cylindrical posts, and an insert (illustrated without a cover) according to an embodiment of the subject matter disclosed herein;

FIG. 2 is a front view of FIG. 1 with the pair of pivotable locking tabs pivoted to release the insert according to an embodiment of the subject matter disclosed herein;

FIG. 3 is an exploded front perspective view like that of FIG. 1 except illustrated rotated 150 degrees and better illustrating a pair of pivot cylinders to which the locking tabs pivot about according to an embodiment of the subject matter disclosed herein:

FIG. 4 is a front perspective view of the insert according to an embodiment of the subject matter disclosed herein;

FIG. 5 is a front perspective view of the receiver base according to an embodiment of the subject matter disclosed herein;

FIG. 6 is a front perspective view of a cover that covers over most of the receiver base when assembled according to an embodiment of the subject matter disclosed herein;

FIG. 7 is a back view of the assembled locking mechanism of FIG. 1 according to an embodiment of the subject matter disclosed herein;

FIG. 8 is a rear perspective view of the assembled receiver base, locking tabs, and insert member according to an embodiment of the subject matter disclosed herein;

FIG. 9 is an exploded rear view of the receiver base, the insert, and the locking tabs and the cylindrical posts of FIG. 1 according to an embodiment of the subject matter disclosed herein;

FIG. 10 is a front perspective view of the locking assembly with the cover placed over the receiver base and the locking tabs according to an embodiment of the subject matter disclosed herein;

FIG. 11 is an exploded front perspective view of the locking assembly of FIG. 10 according to an embodiment of the subject matter disclosed herein;

FIG. 12 is an assembled front perspective view of an alternate embodiment of the locking mechanism illustrating a receiver base, a pair of pivoting locking tabs, an insert, and an electronic bay with electronic components to provide a second stage of locking the locking mechanism (illustrated without a cover) according to an embodiment of the subject matter disclosed herein;

FIG. 13 is a front view of the locking mechanism of FIG. 12 according to an embodiment of the subject matter disclosed herein;

FIG. 14 is a front exploded view of the insert removed from the receiver base and the pivotable locking tabs pivoted to allow release of the insert according to an embodiment of the subject matter disclosed herein;

FIG. 15 is a rear view of the receiver base of FIG. 13 according to an embodiment of the subject matter disclosed herein;

FIG. 16 is an exploded side view of the insert attached to a strap, the receiver base attached to a strap, and the cover;

FIG. 17 is a schematic view of an alternate strap attachment means according to an embodiment of the subject matter disclosed herein;

FIG. 18 is a schematic view of a cable that may be received by the alternate attachment means disclosed in FIG. 17 according to an embodiment of the subject matter disclosed herein;

FIG. 19 is a schematic solid state wiring diagram of the electronic components of the harness side Bluetooth board according to an embodiment of the subject matter disclosed herein;

FIG. 20 is a front view of an another alternate embodiment disclosing a secondary or tertiary locking element with an optional press button mechanism according to an embodiment of the subject matter disclosed herein:

FIG. 21 is an exploded front view of the embodiment of FIG. 20 according to an embodiment of the subject matter disclosed herein;

FIG. 22 is a bottom exploded view of the embodiment of FIG. 20 according to an embodiment of the subject matter disclosed herein;

FIG. 23 is an enlarged bottom perspective view of the press button mechanism of FIG. 20 according to an embodiment of the subject matter disclosed herein;

FIG. 24 is an enlarged top perspective view of the press button mechanism of FIG. 20 according to an embodiment of the subject matter disclosed herein;

FIG. 25 is a schematic view of the locking mechanism connecting two devices together and electronically connected to a controller for communicating signals to an optional computer when the connection is broken according to an embodiment of the subject matter disclosed herein;

FIG. 26 is a perspective view of a locking mechanism system having a steel cable harness attached thereto according to an embodiment of the subject matter disclosed herein;

FIG. 27 is a perspective view of a locking mechanism system having a nylon webbing harness attached thereto according to an embodiment of the subject matter disclosed herein;

FIG. 28 is a system view of a human lift device that utilizes one or more of the locking mechanism systems from FIG. 26 or 27 according to an embodiment of the subject matter disclosed herein;

FIG. 29 is a block diagram of the human lift device system of FIG. 28 according to an embodiment of the subject matter disclosed herein;

FIG. 30 is a system diagram of a fall protection system having multiple stage locking mechanism of above-described embodiments according to an embodiment of subject matter disclosed herein;

FIG. 31 shows an embodiment of a locking mechanism having a visual indicator and an integral Reed switch assembly suitable for use in the fall-protection system of FIG. 30 according to an embodiment of the subject matter disclosed herein; and

FIG. 32 shows a fall-protection system within a larger overall safety system having additional safety and comfort features for a worker engaged in work using this system according to embodiments of the subject matter disclosed herein.

### DETAILED DESCRIPTION

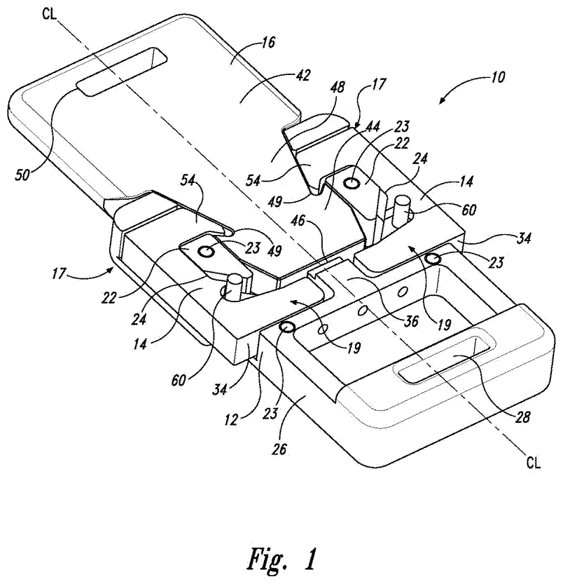

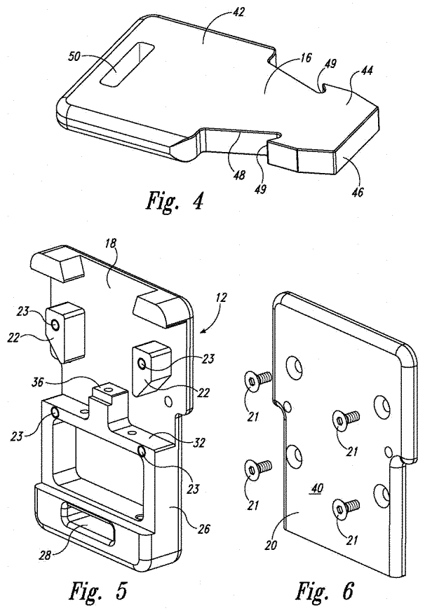

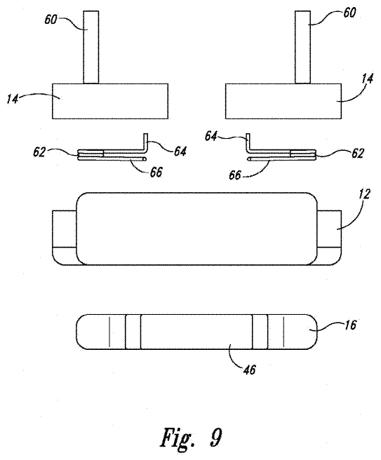

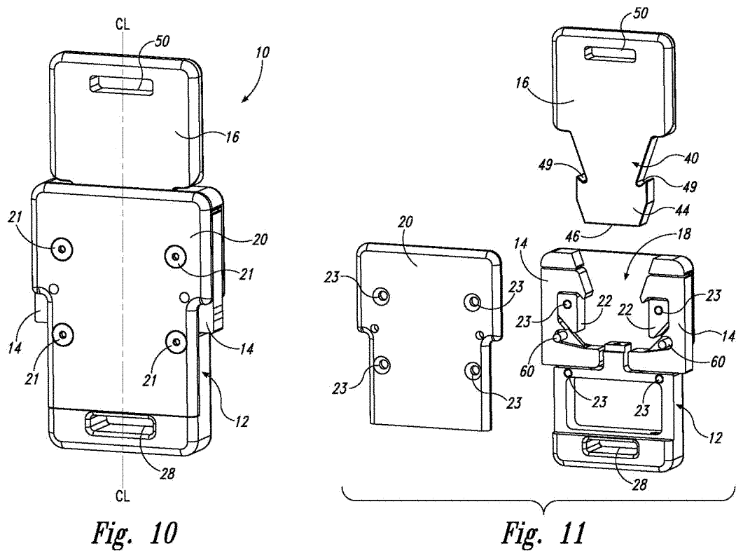

Referring to FIGS. 1-11 and 16, locking mechanism 10 brings two devices together and maintains the connection until such time the connection is intentionally broken. Locking mechanism 10 includes a receiver base 12, a pair of pivotable locking tabs 14, and an insert 16 of which a portion is received within a cavity 18 of receiver base 12 and held in place by locking tabs 14. An optional cover 20 (FIGS. 6, 10) may cover the majority of receiver base 12 and the majority of locking tabs 14 through fasteners 21 received into apertures 23 (such as those illustrated) or other commonly known fastener means.

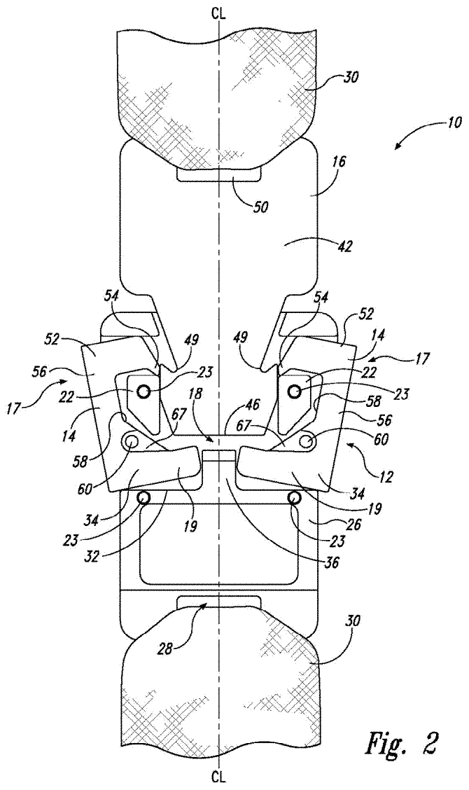

Receiver base 12 includes two spaced-apart and outwardly-projecting chocks 22 that conform to the shape of an interior surface 24 of locking tabs 14 and further define the boundaries of the cavity 18 in which a portion of insert 16 is received. Receiver base 12 also includes a lower section 26 that is configured to engage a first device. According to one embodiment, lower section 26 contains an opening 28. The opening may be an elongated slot (as illustrated in FIGS. 1-3 and 5) to accommodate a safety strap 30 (see FIG. 2 for example) that is operatively connected to a first device, such as a safety harness for example. Opening 28 may be aligned below cavity 18 relative to centerline CL of receiver base 12.

Receiver base 12 may also include a generally central ledge 32 to which bottom portions 34 of the locking tabs rest against when in the locked position. Receiver base 12 may also include an optional central abutment member 36 to which a portion of insert 16 abuts when the insert is fully engaged and in the locked position relative to the receiver base and engaged by the locking tabs (as illustrated in FIG. 1).

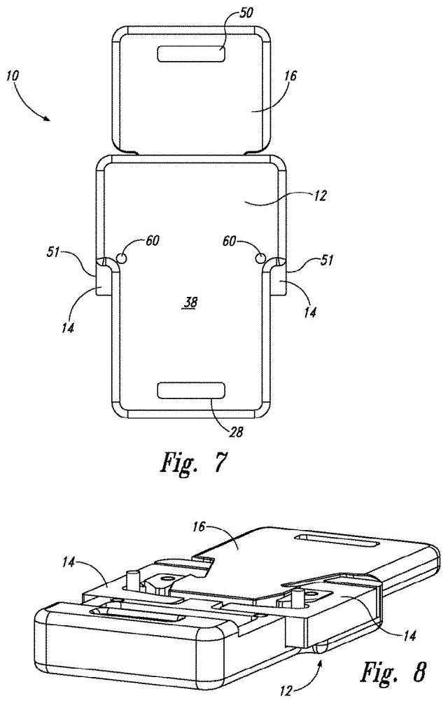

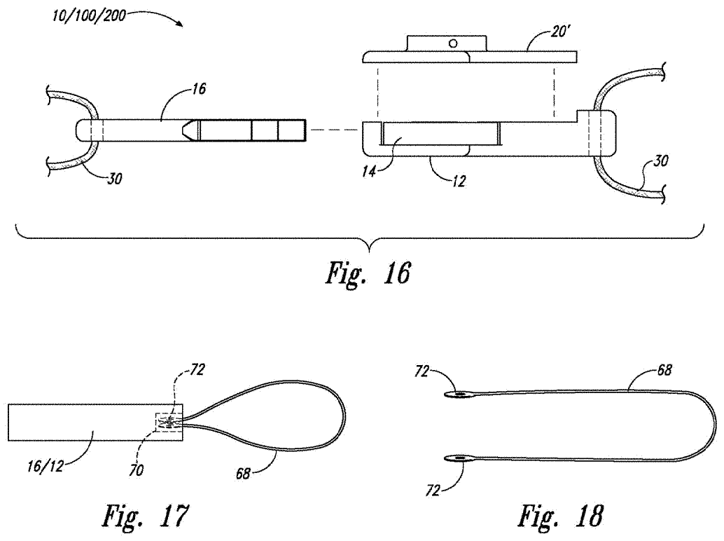

According to one aspect of one embodiment, receiver base 12 has a planar back surface 38 (see FIG. 7). In one form, cover 20 also includes a smooth planar exterior surface 40 (see FIG. 6). When the cover is assembled onto the receiver base 12, the two major surface of the assembled locking mechanism are smooth, planar, and parallel to each other (see for example FIGS. 10 and 16).

Insert 16 may be in the form of a solid planar slab 42 having a lower portion that includes an external “key like” projection 44 having a leading edge 46. Between projection 44 and an upper portion is a transition section 48 that forms a pocket 49 on each side of transition section 48. In one form, the transition and the “key like” projection are received into cavity 18 of receiver base 12 along centerline CL when the insert is inserted into the receiver base in order to lock the locking mechanism. In the fully locked position, end surface 46 abuts the center ledge of the receiver base, or, alternatively, the central abutment member 36 as illustrated in FIG. 1. Opposite end surface 46 within slab 42 is an opening 50 that engages an object, such as a safety strap like safety strap 30. Opening 50 may be an elongated slot similar to opening 28 within receiver base 12.

Insert 16 is configured to be centerline-received into cavity 18 with “key like” projection 44 and at least part of transition section 48 being able to be inserted within cavity 18 formed by receiver base 12, locking tabs 14, and chocks 22. In one form, leading edge 46 abuts central ledge 32 or central abutment 36. Opening 50 within insert 16 is aligned above opening 28 of the lower portion of receiver base 12.

Locking tab 14 may be of various shapes. The locking tabs each have a first arm 17 and a second arm 19 extending outwardly from a central point (the pivot point) where the first arm, second arm and pivot may form a general “L” shape. The first arm engages the lower portion of the insert, i.e., the “key like” projection and at least a portion of transition section 48. According to one embodiment, each locking tab has a top portion 52 that may be configured with a hook nose 54, a side portion 56, and bottom portion 34 (already introduced above). Each locking mechanism has an exterior surface 51 adjacent the pivot point. Top portion 52, side portion 56, and bottom portion 34 form an elongated “c-shaped” cavity 58 that corresponds to the shape of chock 22. In one form, the locking tabs' outer surfaces (defined by the top portion, side portion, and bottom portion) have generally straight surfaces so that the exterior appears to be a partial rectangle. The second arm of each locking tab includes an upper surface 59 that is configured to contact leading edge 46 of insert 16 during unlocking. The second arm further includes a lower surface 61 that may rest on central ledge 32 of receiver base 12 when the locking mechanism is locked.

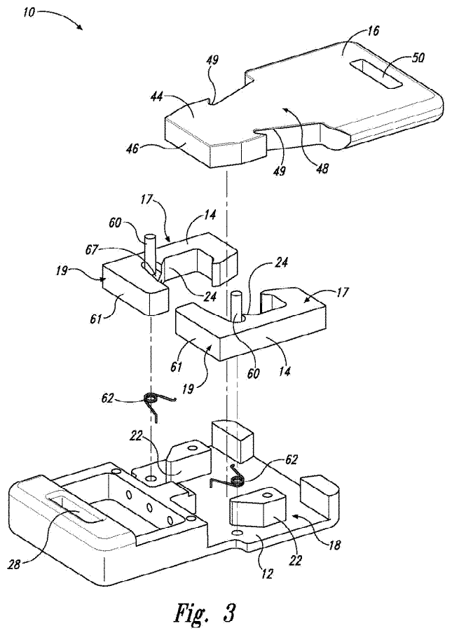

A cylindrical post 60 is inserted axially through bottom portion 34 and operatively connected to receiver base 12 (such as press fit connected into a tapped and threaded hole (see FIG. 3) or through other standard fastening means well known in the industry). In this way, bottom portion 34, side portion 56, and top portion 52 with nose 54 pivot about cylinder post 60 and are rotationally limited by its corresponding chock 22 and central ledge 32, as well as engagement with pocket 49 by nose 54 when insert projection 44 and at least a portion of the insert transition section 48 is inserted into cavity 18.

A torsion spring 62 is positioned between the receiver base and each locking tab about cylindrical post 60. Each torsion spring includes a first arm 64 extending from one end of the coiled spring that biases its respective locking tab and a second arm extending from the other end of the coiled spring that biases the adjacent chock 22. The torsion spring for the right side locking tab is the mirror image of the torsion spring for the left side locking tab. The torsion spring allows rotational movement with an indented general arc on the back side of each locking tab about the pivot post (cylindrical post). The same general indented arc 67, but on the front side of the locking tab is illustrated in FIGS. 2 and 3.

When the locking mechanism is in the fully locked position (see FIG. 10), the exposed parts are mostly planar, which makes the locking mechanism less likely to get snagged or hooked during use. When the locking mechanism is unlocked, each first arm extends beyond outer edges of the receiver base. The extending first arms past the receiver base (see e.g., FIG. 14) are visible to a worker or third parties. Further, the outer edges of the insert, receiver base, and locking tabs may be chamfered to further reduce the potential of snags or hang ups. Cover 20 may be configured to leave the pivot comer of the locking tab, or at least exterior surface 51 of each locking tab 14, exposed for easy access.

Each top portion of the locking mechanism 52/54 engages one side of the insert projection 44 to retain and hold the insert projection within cavity 18 that is bordered by the receiver base, the chocks, and the first and second arms of each locking tab. To disconnect (unlock) the insert from the cavity, a user applies force on exterior surface 51 located near the pivot point on each locking tab in order to cause rotational movement of each second arm of the locking tab relative to its corresponding first arm of the locking tab. The second arm applies a force on the insert projection leading edge 46 and the first arm no longer engages the sides of insert projection 44. Exterior surface 51 may include knurling or other surface roughening for a worker to more easily engage the point of disconnection on locking tab.

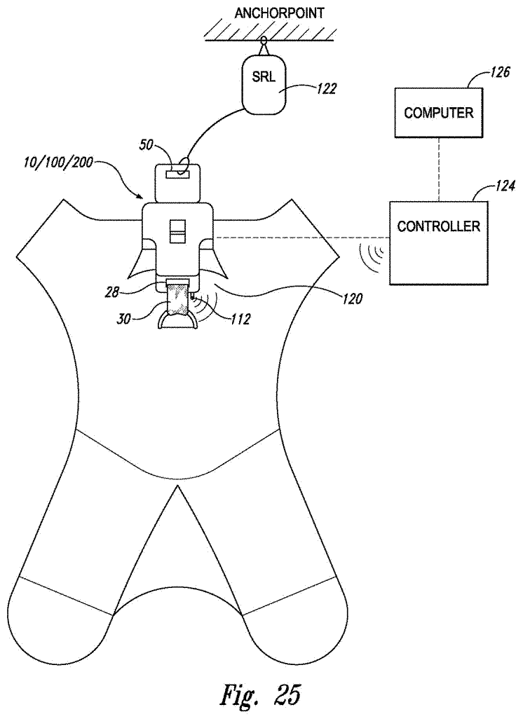

In use, as illustrated in FIG. 25, locking mechanism 10 may be used to connect two devices together through attachment of the two devices to the insert and the receiver base, respectively. Locking mechanism 10 is particularly well suited to joining a first device, such as a safety harness 120 worn by a worker, that includes or is connected to safety straps, webbing, or cable, or some form of connector, where the safety strap, webbing, cable, or connector engages the receiver base, such as through opening 28. The insert, such as through insert opening 50, engages with a second device, such as a retractable lifeline 122, that itself includes or is connected to safety straps, webbing, cable, or connector. Other engagement means can be used such as those illustrated in FIGS. 17 and 18.

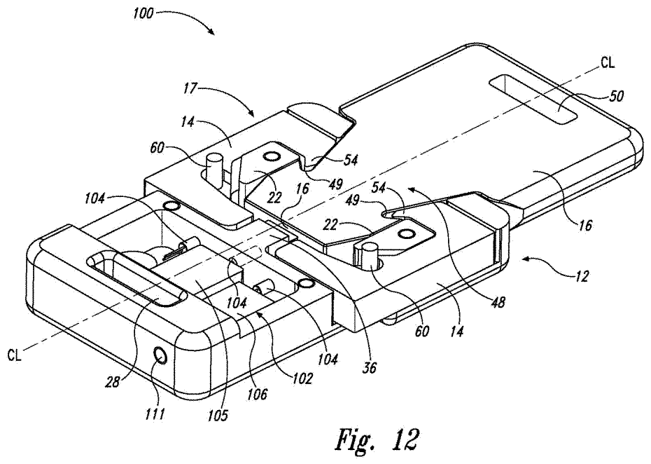

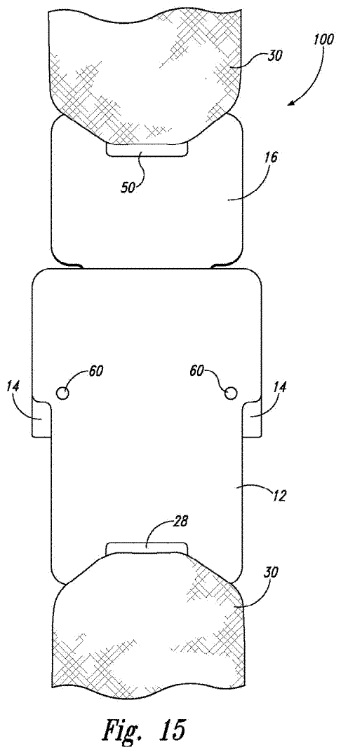

Referring now to FIGS. 12-15 and 19, a second embodiment locking mechanism 100 is directed to two-stage locking verification. Similar to locking mechanism 10 above with one-stage mechanical locking, second embodiment 100 includes the same one-stage mechanical locking features above. The same numeral designations are used to describe the second embodiment locking mechanism's mechanical locking functionality. That is that the second embodiment locking mechanism includes a receiver base 12, a pair of locking tabs 14, an insert 16.

However, receiver base 12 also includes an electronic bay 102 that includes various electronic components to verify that insert 16 is fully engaged into cavity 18 and latched by locking tabs 14. The electronic components send a signal to an external device (such as a computer) that determines whether the locking mechanism can open and release the insert through the first locking means.

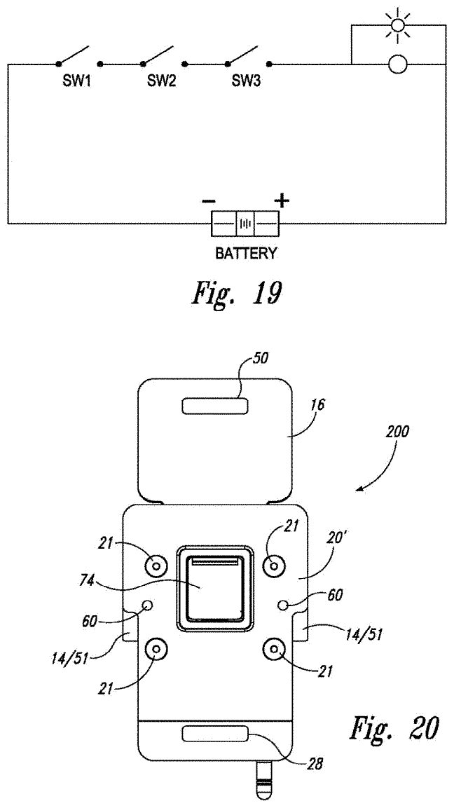

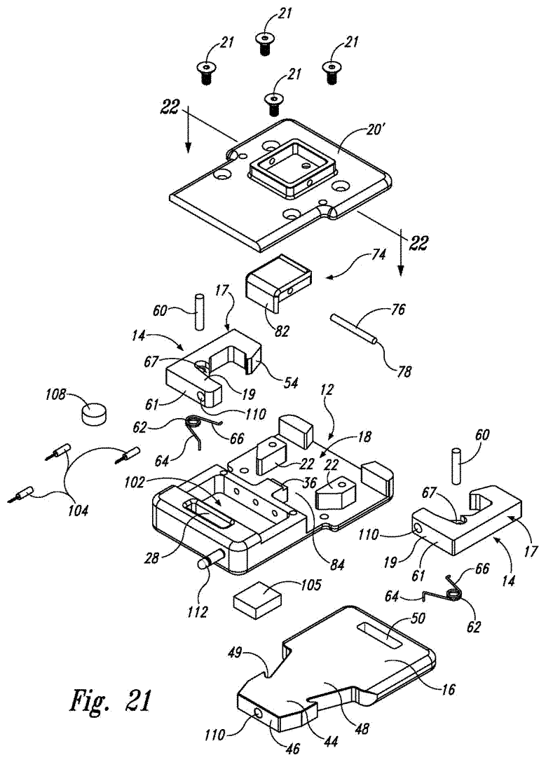

Referring also to FIG. 19, electronic components may include embedded reed switches 104, a circuit board 105, a relay 106, embedded shielded proximity switches, a pressure switch that has mechanical engagement, an optical sensor, and optional indicator light (e.g., LED light) and a battery 108. These are positioned within the electronic bay 102. There are also magnetic actuators 110, preferably three, to match a corresponding reed switch 104. Magnetic actuators 110 are positioned outside the electronic bay (see for example FIG. 21).

The reed switches 104 may be a Hamlin 59010 Firecracker (3 mm dia., 9 mm long). They will be activated by the magnetic actuators placed in three locations opposite the reed switches. One location will be at the end of the insert, another under the left hand locking tab, and the remaining one under the right hand locking tab. All three switches will normally be in the open position until the magnetic actuator changes their state.

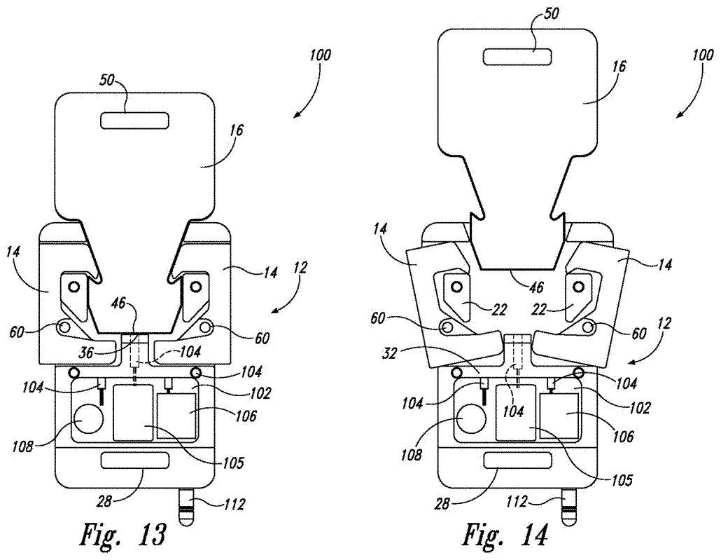

After all three switches are closed by the mechanical action of inserting the insert into the receiver base cavity (one-stage locking), then the electronic components will receive electrical energy from the battery. After the electronic components have communicated via various protocols, such as Bluetooth, near field communication, RFID, Zigbee, or other wireless communication means, that the mechanical (stage one) locking has taken place, a remote computer/processor processes the safe signal, that may be sent via a wireless antenna 112 (see e.g., FIG. 13), received with an aperture 111 within receiver base 12, and will close the dry contacts, such as on a machine interface board (not illustrated). The sensed signal will block electrical signals to an affected machine control function (stage two). Here, in the second stage, the locking mechanism 100, through mechanical closure, triggers a communication between the locking mechanism 100 to a machine (not illustrated) that may be attached to or a controller 124 (see e.g., FIG. 25) that may be interfaced with a machine or multiple machines or to a complete overall monitoring system.

The two-stage locking mechanism with verification capabilities (e.g., remote processor signaling) is particularly useful for dangerous applications where human life (or safety) is at risk or where sensitive expensive equipment is at risk. One application for the two-stage locking mechanism 100 is between a worker in a safety harness 120 and a retractable lifeline 122 where an employer (or construction boss) needs to ascertain with more certainty whether it is safe for a worker to detach from a lifeline. The connection or disconnection can be signaled to a controller 124, which can be forwarded to a computer device 126 that can be networked with an internal or external safety monitor command center (not illustrated). Further, the locking mechanism (10 or 100) allows a worker to remove him or herself from a lifeline without removing the worker's safety harness.

FIGS. 17 and 18 illustrate a different means for engaging a cable 68 or strap. Instead of a safety strap being threaded between openings 28 and 50 of the receiver base and insert, respectively, the cable or strap ends are captured within an opening 70 that opens through the outer edge of the receiver base and/or insert as illustrated in FIG. 17. Cable or strap 68 includes flexible expanding end portions 72 that can be inserted into opening 70 but cannot come out without cutting the cable/strap. Alternatively, cable ends can be epoxied or other permanent fastening means within opening 70.

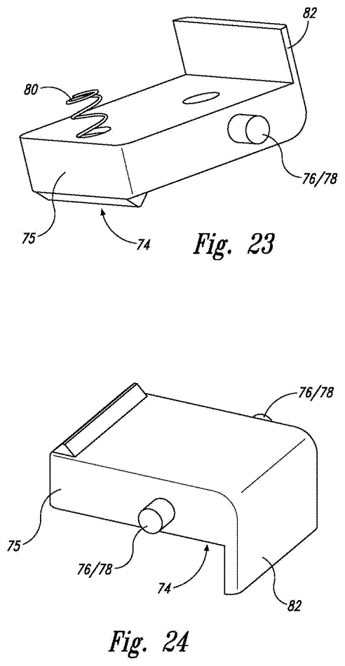

FIGS. 20-24 disclose another alternate embodiment locking mechanism 200 with either secondary or tertiary locking verification means. Locking mechanism 200 can be used in connection with the one-stage locking verification means found in locking mechanism 10 or used with locking mechanism 100 (two-stage locking verification means), depending on the type of application that is desired. Locking mechanism 200 contains a receiver base 12, a pair of locking tabs 14, and an insert 16 all like those elements described in detail above. Cover 20′ however is different from cover 20 in that it is adapted to accommodate a centrally positioned push button mechanism 74.

Push button mechanism 74 includes a centrally positioned rod 76 that extends past the confines of a mechanism housing 75 to form ends 78. The mechanism housing is operably connected to a spring 80 that is biased against the interior of the receiver base.

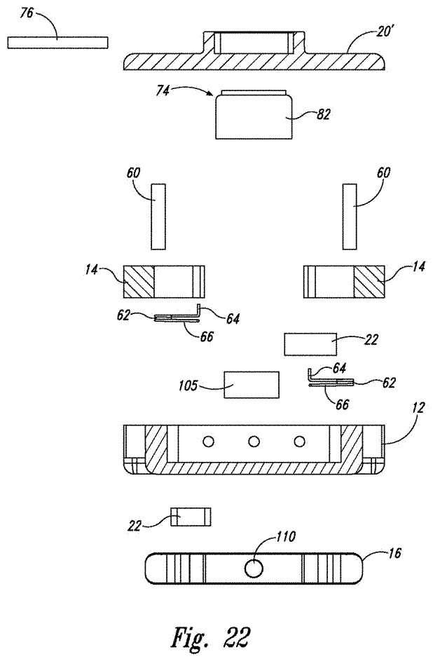

During locking action, a lower lip 82 extends from mechanism housing 75 that engages with a slot or indent within the receiver base 84, such as on central abutment member 36, (FIG. 22). Lower lip 82 also is positioned directly above upper surface 59 of each locking tab lower arm. The physical relationship between the lower lip 82 and the locking tab lower arms, which may be touching but does not need to be, keeps the locking tabs from rotational movement until the button retracts the lower lip and the two locking tabs are rotated to disengage the insert projection from the cavity.

Torsion springs 62, as discussed above, may be embedded under each locking tab to keep inward tension of the locking tabs. The torsion springs mount around a respective cylindrical post (or pivot pin) to tension the spring with regard to its corresponding locking tab so that a user would need to squeeze them with approximately 5 lbs of pressure in order to release (pivot) the locking tabs.

When pressing the push button mechanism 74, it retracts the lower lip 82 and, therefore, disengages with the indent or slot 84 in receiver base 12 and no longer stops the lower arms of the locking tabs from rotation (and displacement of the leading edge of the insert). Then a user may squeeze on the two locking tabs at the same time as the push button is depressed to effectuate three point mechanical unlocking of the locking mechanism 10.

If used with the locking mechanism 100, the push button mechanism 74 along with the pivotable locking tabs act as a tertiary locking action to the two-stage locking verification means described to locking mechanism 100 (mechanical locking of the insert in the first stage, and electronic locking means of the second stage). In this embodiment, the push button must be depressed at the same time as depressing the locking tabs in order to pivot the locking tabs to disconnect (unlock) the insert from the locking tabs and receiver base cavity. The push button and two locking tabs form a three point contact before locking or unlocking can take place.

The locking mechanisms 10, 100, 200 may be made of metal or man-made materials. In one form, locking mechanisms 10, 100, and 200 are made of aluminum. In another form they are made from carbon fiber as a strong, yet lightweight, alternative.

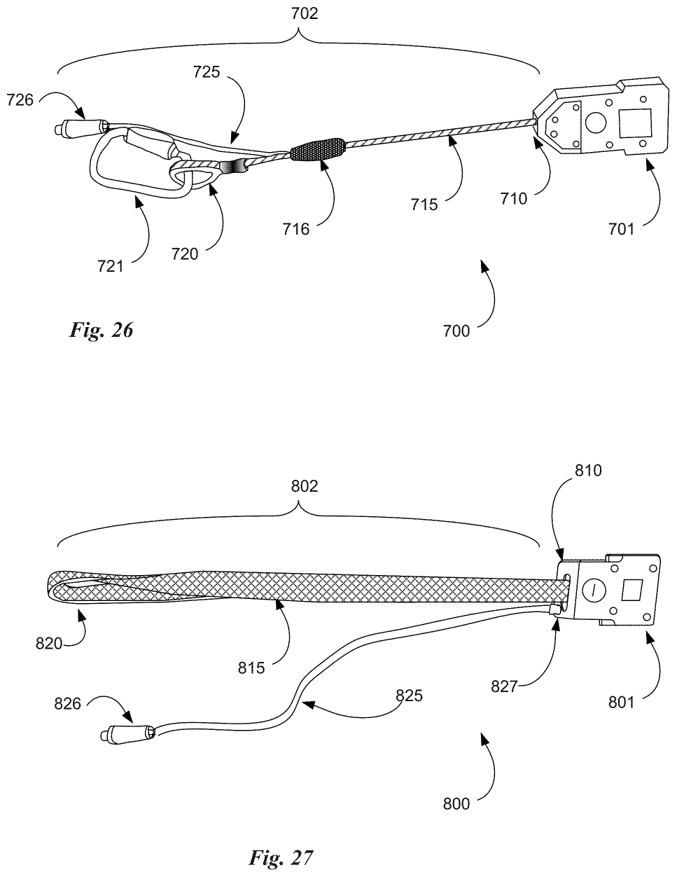

FIGS. 26-28 show additional embodiments that take advantage of remote signal processing for determining the status of the locking mechanisms via communications signals that are transmitted and received through an attached cable. In various embodiments discussed above, electronic circuitry may be used to determine whether specific locking points have been perfected, thereby ensuring the the locking mechanism is properly secured. In the embodiment that follow, the various electronic circuitry may further receive power and be in communication with at attached umbilical cord that may or may not be part of an overall harness system.

FIG. 26 is a perspective view of a locking mechanism system 700 having a steel rope harness 702 attached to a locking mechanism 701 according to an embodiment of the subject matter disclosed herein. As used herein, the harness 702 refers to the attachment assembly or linking member that may be coupled to the locking mechanism 701 on one end as well as attached to an anchor point (e.g., a railing of a human lift system) at some location remote form the locking mechanism 701. The harness 702, as used herein includes the components of FIG. 26 except for the locking mechanism 701 itself. Further, the locking mechanism 701 may be any one of the embodiments described previously, e.g., locking mechanisms 10, 100 and 200. As such, the harness 702, in this embodiment, includes a steel rope 715 that is removably coupled to an assembly attachment point 710 on the locking mechanism 701. In other embodiments, this coupling may be permanent and integral with the locking mechanism 701.

The harness 702 may further include a means for attaching the harness to an anchor point, such as a railing of a human lift system, railing of scaffolding, or wall or roof of a building. In this embodiment, the steel rope 715 culminates in a loop 720 that may be engaged with a carabineer 721. A skilled artisan understands that any means of attachment or anchoring may be realized and that the length of the steel rope 715 may be longer than depicted in FIG. 26. Together, the harness 702 and the locking mechanism 701 completes the locking mechanism system 700 such that a person who engages the locking mechanism system may be protected from falls from high places, such as a scaffolding (not shown) or human lift device (not shown).

The harness may further include a signal cable 725 that culminates in a connector 726. The signal cable 725 may be disposed inside the steel rope 715 for a sizable length of the harness 702. The steel rope 715 may include an exit point 716 for the signal cable 725 to no longer be disposed within the steel rope 715. In this manner, the signal cable 725 is protected inside the steel rope 715 portion of the harness 702 so that the signal cable 725 will avoid being pulled the way that the steel rope 715 may be pulled when preventing accidentals falls and the like. That is, the steel rope 715 will provide tensile strength for the harness 702 and will avoid breaking or otherwise compromising the signal cable 725 as it is protected inside the steel rope 715. In this manner, signals may be transmitted to and from the locking mechanism 701 to the signal cable connector 726.

The signal cable connector 726 is configured to be interfaced with some manner of control system or monitor system (e.g., local or remote controller) that is remote from the locking mechanism 701. Thus, the remote monitor system (not shown) may provide one or more power signals to the locking mechanism 701 for powering various on-board circuitry. Further, or even alternatively, the remote system may deliver low-power control signals or monitor signals that are used to determine of the various switches disposed in the locking mechanism indicate that the locking mechanism is properly engaged with an inserted device, thereby ensuring that the overall locking mechanism system is properly engaged. Thus, a monitor circuit may include a signal source located remotely (with respect to the locking mechanism 701) that may send a signal to the indicator switches inside the locking mechanism (two or three, depending on the embodiment as discussed previously). If each of the indicator switches in the series in in a closed state, then the circuit is “made up” and the remote system receives the return signal indicating that the locking mechanism 701 is properly engaged. If the signal is not returned and the circuit remains open due to one or more indicator switches remaining open, then the remote system determines that the insert device is improperly engaged.

FIG. 27 is a perspective view of a locking mechanism system 800 having a nylon webbing harness 802 attached to a locking mechanism 801 according to an embodiment of the subject matter disclosed herein. As used previously, the harness 802 refers to the attachment assembly that may be coupled to the locking mechanism 801 on one end as well as attached to an anchor point (e.g., a railing of a human lift system) at some location remote from the locking mechanism 801. Further, the locking mechanism 801 may be any one of the embodiments described previously, e.g., locking mechanisms 10, 100 and 200. As such, the harness 802, in this embodiment, includes a woven nylon member 815 that is removably coupled to an assembly attachment point 810 on the locking mechanism 801.

The harness 802 may further include a means for attaching the harness to an anchor point, such as a railing of a human lift system, railing of scaffolding, or wall or roof of a building. In this embodiment, the woven nylon member 815 culminates in a loop 816. A skilled artisan understands that any means of attachment or anchoring may be realized and that the length of the woven nylon member 815 may be longer than depicted in FIG. 27. Together, the harness 802 and the locking mechanism 801 completes the locking mechanism system 800 such that a person who engages the locking mechanism system 800 may be protected from falls from high places, such as a scaffolding (not shown) or human lift device (not shown).

The harness 802 may further include a signal cable 825 that culminates in a connector 826. The signal cable 825 may be disposed along side the woven nylon member 815 for the entire length of the harness 802 with a little bit of length to spare when compared to the length of the woven nylon member 815. In this manner, the signal cable 825 is protected by the woven nylon member 815 portion of the harness 802 because the signal cable 825 will avoid being pulled the way that the woven nylon member 815 may be pulled when preventing accidentals falls and the like. That is, the woven nylon member 815 will provide tensile strength for the harness 802 and will avoid breaking or otherwise compromising the signal cable 825. In this manner, signals may be transmitted to and from the locking mechanism 801 to the signal cable connector 82 through a signal cable port 827. The signal cable connector 826 operates in a similar manner to the signal cable 825/signal connector 826 tandem as discussed above with respect to FIG. 26.

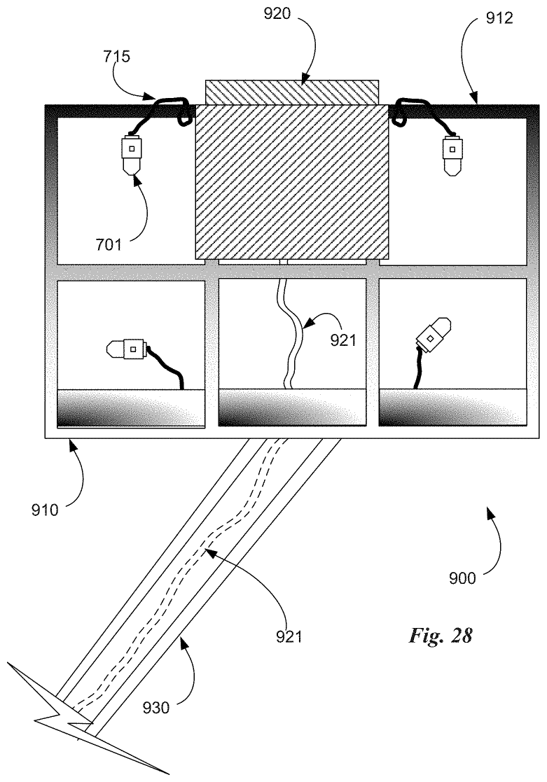

FIG. 28 is a system view of a human lift device 900 that utilizes one or more of the locking mechanism systems from FIG. 26 or 27 according to an embodiment of the subject matter disclosed herein. In this embodiment, e.g., the system 900 includes a basket 910 or personnel workspace that may be lifted into the air from a lift mechanism (not shown) via a boom arm 930. In this manner, a worker may be lifted to a work area. For safety, the worker will latch into one or more locking mechanisms 701. In FIG. 28, four locking mechanisms 701 along with four respective steel ropes 715 are shown. The basket includes safety railing to assist with keeping workers safely in the workspace. As such, the steel ropes 715 may be anchored to the one or more railings or one or more secure and stationary portions of the basket 910.

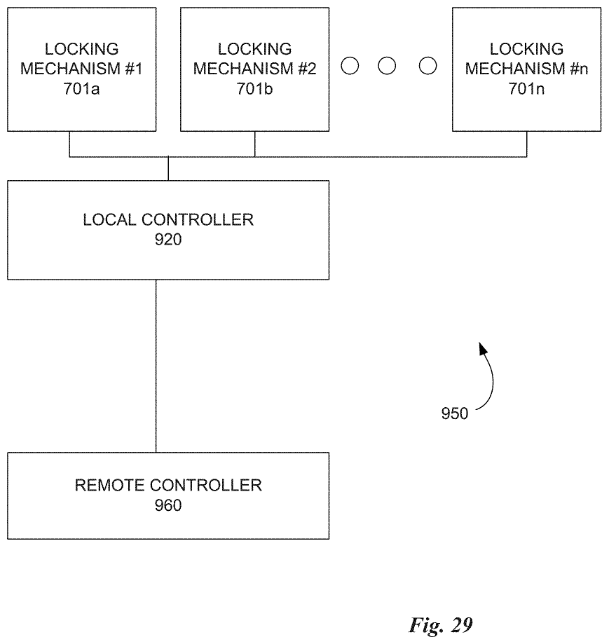

These embodiments of the locking mechanisms 701 may include a signal cable 725 disposed inside the steel ropes 715 such that the signal cable 725 may attach to a local controller 920. In this manner, the local controls may be locked out until one or more of the locking mechanisms indicate a proper latch with an insert device (that is coupled with a worker such as a 5-point safety harness or safety suit (not shown)). In other embodiments, each signal cable joins a larger signal cable run 921 that connects to a remote controller at the other end of the boom arm 930. As such, the remote controller may similarly be locked out of operation until one or more locking mechanisms 701 indicate correct insertion with a safety device. The overall system 900 is further understood with respect to the system block diagram of FIG. 29.

FIG. 29 is a block diagram 950 of the human lift device system of FIG. 28 according to an embodiment of the subject matter disclosed herein. The system includes one or more locking mechanisms 701a, 701b, - - - 701n. Each respective locking mechanism may be communicatively coupled to a local controller 920. In this manner, the local controller 920 is configured to send a signal to each locking mechanism. If each indicator switch is closed (indicative of an insert device properly engaged with the locking mechanism), then a return signal is sensed through a series circuit that is completed. The local controller 920 may be configured to be locked out if none of the locking mechanisms 701a, 701b, - - - 701n indicate being properly engaged. In other embodiments, the local controller 920 may be locked out is any one of the locking mechanisms 701a, 701b, - - - 701n does not indicate a complete signal circuit.

Further, each respective locking mechanism 701a, 701b, - - - 701n may be communicatively coupled to a remote controller 960. In this manner, the remote controller 960 is also configured to send a signal to each locking mechanism. If each indicator switch is closed (indicative of an insert device properly engaged with the locking mechanism), then a return signal is sensed through a series circuit that is completed. The remote controller 960 may be configured to be locked out if none of the locking mechanisms 701a, 701b, - - - 701n indicate being properly engaged. In other embodiments, the remote controller 960 may be locked out is any one of the locking mechanisms 701a, 701b, - - - 701n does not indicate a complete signal circuit. With a remote controller 960, the signals may be routed through the local controller 920 such that both the remote controller 960 and the local controller 920 are enabled or locked out in unison.

### Systems for Using Multiple Stage Locking Mechanism

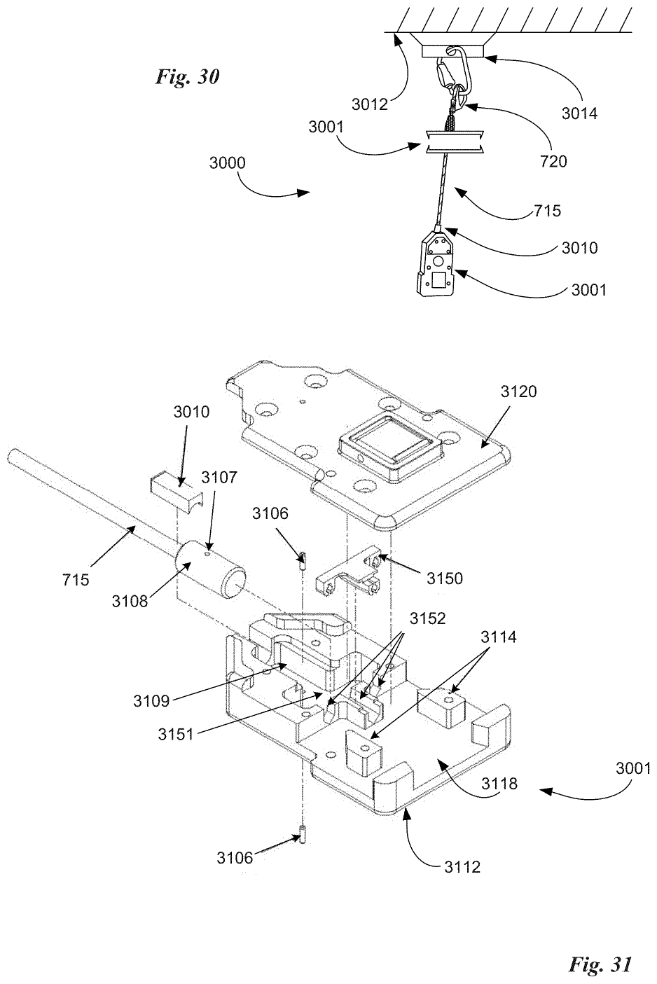

The above-described embodiments of a multiple stage locking mechanism may have application and use in several different scenarios and work settings. Thus, several embodiments are disclosed that take advantage of such a versatile and robust locking mechanism with respect to FIGS. 30-32.

FIG. 30 is a system diagram of a fall-protection system 3000 having one or more multiple stage locking mechanisms of above-described embodiments according to an embodiment of subject matter disclosed herein. A fall-protection system, such as the fall-protection system 3000 shown here, is designed to protect workers that may be working at dangerous heights or near leading edges of workplace settings. A leading edge refers to an end of a work surface and the beginning of a fall hazard and it also carries specific meaning within standards associated with fall-protection equipment and self-retracting lifelines (SRLs). Prior to discussing aspects of the fall-protection system 3000 of FIG. 30, a brief discussion about fall protection equipment standards is presented next.

One such standard recognized in the United states is American National Standards Institute (ANSI) Z359.14 Class A Standard. This standard establishes requirements for the performance, design, qualification testing, markings and instructions, inspections, maintenance and storage, and removal from service of fall-protection equipment including self-retracting devices (SRDs), self-retracting lanyards (SRLs), self-retracting lanyards with integral rescue capability (SRL-Rs), and self-retracting lanyards with leading edge capability (SRL-LEs). This standard establishes requirements for fall-protection equipment intended for use in personal fall arrest or rescue systems for authorized persons within the capacity range of 130 to 310 pounds.

Fall-protection equipment may take on several form factors with differing functionality depending on the environment is which intended use is desired. Fall-arrest systems and self-retracting lifeline fall protection for workers alleviates risk to workers near leading edges or at-height. Additionally, fast-activating braking systems reduce fall distances and forces produced from falls. As the use of fall-protection equipment and self-retracting devices increases, the American National Standards Institute sets, maintains, and updates standards for use and maintenance of these life-saving systems.

In order for fall-protection equipment to comply with ANSI Z359.14, a manufacturer is obligated to indicate in user instructions specific inspections the end user must complete. The end user must comply with these instructions in order to ensure that all fall-protection equipment is operating correctly and continues to be in compliance with these ANSI regulations. Depending on the amount of use specific fall-protection equipment gets, these inspections are annual, semi-annual, or quarterly. Such factory authorized inspections are in-depth inspections of the equipment by trained and authorized specialists. Furthermore, after each fall event, the fall-protection equipment must be inspected prior to redeployment into use in the work setting.

One aspect of the ANSI standard mandates that each fall-protection device or self-retracting lifeline device include one or more visual indicators, easily visible, that indicates that a fall event has occurred. For example, one visual indicator may include a ring built into a snap hook or a tear away section of a lead line link. When a fall event occurs, the hook is snapped or torn away revealing a bright red fall tag or bright red stitching such that an inspector may easily see that this equipment recently experienced a fall event. However, in some factory setting, an anchor point for the lead lines may be in a ceiling or rafters of the factory floor. As some factory floors have ceiling well over 100 feet from the ground, being able to visually inspect the visual indicator become increasingly difficult. That is, the bright red tag that indicates that a fall event has occurred does not look as bright 100 feet away. Thus, a system that can function in this setting while still providing fall protection but with better visual indication can overcome this problem.

Turning attention to the fall-protection system 3000 of FIG. 30, this system includes a locking mechanism 3010 that includes an indicator device 3010 that is disposed much closer to the worker (e.g., where the locking mechanism 3001 engages a personal worker harness (not shown in FIG. 30). In this embodiment, the fall-protection system 3000 is suited to be deployed in a working environment in which the anchor point is a large distance above the work space. Thus, a cable anchor 3014 may be attached to a workplace ceiling 3012 or rafter. A long (100 feet or more) lead cable 715 (e.g., steel rope or other similar suitable cable) may be coupled to the cable anchor 3014 using a suitable mechanical coupling device such as a carabineer 721. For ease of illustration in FIG. 30, a break 3001 in the lead cable 715 is shown so that the entire long length of the lead cable 715 is indicated without cluttering the drawing. The lead cable 715 may include a loop 720 at one end as discussed above with respect to FIG. 26 so as to engage the carabineer 721 that, un turn, engages the cable anchor 3012 at the ceiling 3014. Alternatively, the lengthy upper section of the lead cable 715 may also culminate at the working end (e.g., near the worker) in another loop 720 and carabineer 721. The lengthy upper section of the lead cable 715 may also culminate at the working end (e.g., near the worker) in coupling directly to the locking mechanism 3001. Further, the lengthy lead cable 3015 may also include a signal cable (not shown) having a signal cable connector (also not shown) as also discussed above with respect to FIG. 26.

With a long lead cable 715 in this system 3000, a worker (not shown) may facilitate engaging the fall-protection system 3000 proximate to a working space. Thus, a worker may utilize the locking mechanism 3001 coupled to the lead cable 715. The locking mechanism 3001 may be any one of the embodiments described previously, e.g., locking mechanisms 10, 100 and 200. Further, the locking mechanism 3001, in this embodiment, includes a load indicator 3010 that is disposed at the lead cable attachment point of the locking mechanism 3001. As shown, the load indicator is in a tripped position to indicate that a fall event has occurred. Typically, the load indicator will be a bright red color to comply with standards. In other embodiments, the load indicator 3010 may be larger or in different colors and will be an integral part of the locking mechanism 3001. These and other aspects of the locking mechanism 3001 are discussed next with respect to FIG. 31.

FIG. 31 shows an embodiment of a locking mechanism 3001 having a visual indicator 3010 and an integral Reed switch assembly 3120 suitable for use in the fall-protection system 3000 of FIG. 30 according to an embodiment of the subject matter disclosed herein. The visual indicator device 3010 provides a means for sensing an overall force exerted on the lead cable 3015 and locking mechanism 3001 of FIG. 30 during a fall event. A fall event may be any activity that exerts a force on the cable/lock assembly such that the load indicator 3010 is pulled away from the body of the locking mechanism 3001. Further, the integral reed switch assembly 3150 is suitable for use in the locking mechanism 3001 whereby an assembly seat 3152 may be bored and machined right in the body of the locking mechanism such that mechanical forces do not impact the sensitive Reed switches through prolonged and repeated use. Each of these novel aspects is discussed in the next paragraphs.

In the embodiment of FIG. 31, only the receiver base 3112 of the locking mechanism 3001 is shown. The locking mechanism 3001 is similar to previously described locking mechanisms 10 as discussed above and brings two devices together and maintains the connection until such time the connection is intentionally broken. Locking mechanism 3001 includes a receiver base 3112, a pair of pivotable locking tabs 3114, and an insert (not shown) of which a portion is received within a cavity 3118 of receiver base 3112 and held in place by locking tabs 3114. An optional cover 3120 may cover the majority of receiver base 3112 and the majority of locking tabs 3114.

Receiver base 12 also includes section that is configured to engage a first device (e.g., a safety cable or cable lead 715). According to one embodiment, this section contains an opening that may be an elongated slot (as illustrated in FIG. 31) to accommodate a cable lead 715 that is operatively connected to an anchor point or additional safety systems, such as a safety harness for example. The opening may include an internal cavity 3109 that includes a greater diameter than the cable opening and is adjacent to cavity 3118 as well as being relative to centerline of receiver base 3112. As such, a cable lead chock 3108 may be secured to the end of the cable lead 715 inside the internal cavity 3109 and secured therein because the opening is not large enough to allow the chock 3108 to be pulled out of the receiver base 3112.

A torsion spring (not shown in FIG. 31) is positioned between the receiver base 3112 and each locking tab 3114 about cylindrical post. Each torsion spring includes a first arm extending from one end of the coiled spring that biases its respective locking tab and a second arm extending from the other end of the coiled spring that biases the adjacent chock. The torsion spring for the right-side locking tab is the mirror image of the torsion spring for the left side locking tab. The torsion spring allows rotational movement with an indented general arc on the back side of each locking tab about the pivot post (cylindrical post). The same general indented arc 67, but on the front side of the locking tab is illustrated in FIGS. 2 and 3.

When the locking mechanism is in the fully locked position (for example, see FIG. 10), the exposed parts are mostly planar, which makes the locking mechanism less likely to get snagged or hooked during use. When the locking mechanism is unlocked, each first arm extends beyond outer edges of the receiver base. The extending first arms past the receiver base (see e.g., FIG. 14) are visible to a worker or third parties. Further, the outer edges of the insert, receiver base 3112, and locking tabs 3114 may be chamfered to further reduce the potential of snags or hang ups. Cover 3120 may be configured to leave the pivot corner of the locking tab 3114, or at least exterior surface of each locking tab 3114, exposed for easy access.

The embodiment of FIG. 31 includes a load indicator 3010 right at the lead cable 715 opening that easily seen and detected by a user of the locking mechanism 3001. Under normal operating conditions, the lead cable chock 3108 is held in a deep position within the internal cavity 3109 by two load pins 3106 that engage load pin holes 3107 on the chock 3108. Being held in a deep position within the cavity 3109, the load indicator is also held within the opening such that the load indicator 3010 cannot be seen. That is, no bright red color, which is typical of the load indicator 3010, can be seen when the load pins 3106 are engaged with the load pin holes 3107 of the chock 3108.

The load pins 3106 is suited to withstand a threshold amount of force exerted on the load cable that may pull the chock toward the opening. Such a threshold, in one embodiment, may be 800 pounds, however, other thresholds may be set using different load pins 3106. If the force on the lead cable 715 exceeds the threshold, e.g., when a fall event occurs, the load pins are released from the load pin holes 3107 thereby forcing the load indicator out of the opening where it can be easily seen. The load indicator 3010 may also be spring loaded such that once it clears the opening, it expands outwardly from the lead cable such that it cannot slide back into the opening. Thus, a fall event releases the load indicator 3010 whereby it is locked into its indicating position outside of the opening.

In some extreme fall events, the overall force exerted can be up to a range of 3,000-5,000 pounds. This force may impact all components of the system including the tensile strength of the lead cable as well as all coupling components. The ANSI standard discussed above limits fall events to 1,800 pounds of force which can be achieved by limiting fall distance before engaging the fall-protection functionality (e.g., less slack, fall sensing equipment such as gyrometers and accelerometers). With the standard limit of 1800 pounds, the mechanical indicator 3010 is suited to detect the overall force exerted between the couplers in at least this extreme range of 0 to 5,000 pounds of force. For example, one may wish to visually indicate any fall event that exerts a force of 800 pounds or more. One example of a fall event that exerts 1000 pounds of force is a 200-pound worker falling four feet before the fall-protection system 3000 arrests the motion within one additional foot of fall travel.

With such a wide range of fall forces being exerted across different events and different circumstances, standards dictate that any fall event that exerts a threshold amount of force show some manner of visual indication that the event occurred. This visual indication is the red load indicator that locks into an indication position if the load pins 3106 release the chock 3108. In this manner, a user may easily see that a previous fall event has occurred. Then, a system specialist may then inspect and recertify good working order of the fall-protection system 3000 and reset the load indicator. In one embodiment, the load indicator 3125 is a bright red color while the remainder of the receiver base 3112 may be black or gray such that the bright red stands out (e.g., is chromatically very different) against the backdrop of the device and locking mechanism.

Turning attention now to the integral reed switch assembly 3150, the embodiment of FIG. 31 is similar to other embodiments in that the receiver base 3112 also includes an electronic bay 3151 that includes various electronic components to verify that an insert is fully engaged into cavity 3118 and latched by locking tabs 3114. The electronic components are configured to send a signal to an external device (such as a computer) that determines whether the locking mechanism 3001 is properly engaged with an insert. These electronic components may include embedded reed switches 104, a circuit board 105, a relay 106, embedded shielded proximity switches, a pressure switch that has mechanical engagement, an optical sensor, and optional indicator light (e.g., LED light) and a battery 108. These components are shown in FIGS. 13 and 14, but not shown in FIG. 31 for clarity. In this embodiment, three reed switches may be integral with a reed switch assembly 3150 and are positioned within the electronic bay 3151 aligned with respective bores of an assembly seat 3152 that is machined into the receiver base 3112. As before, the insert may include three magnetic actuators to match a corresponding reed switch when inserted. Having a machined assembly seat 3152 in addition to a three-reed-switch assembly 3150 prevents damage to the sensitive components of the electronics bay during manufacturing.

The reed switches 104 may be a Hamlin 59010 Firecracker (3 mm dia., 9 mm long). They will be activated by the magnetic actuators placed in three locations opposite the reed switches. One location will be at the end of the insert, another under the left hand locking tab, and the remaining one under the right hand locking tab. All three switches will normally be in the open position until the magnetic actuator changes their state.

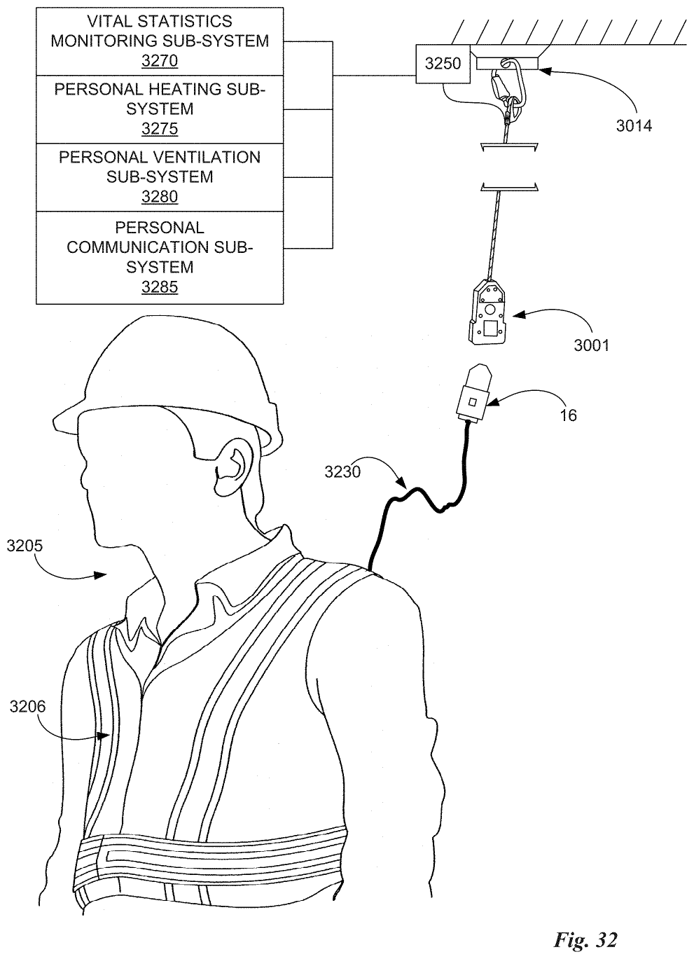

After all three switches in the reed switch assembly 3150 are closed by the mechanical action of inserting the insert into the receiver base 3112 (first stage), the electronic components will receive electrical energy from the battery. After the electronic components have communicated via various protocols, such as Bluetooth, near field communication, RFID, Zigbee, or other wireless communication means, that the mechanical (stage one) locking has taken place, a remote computer/processor processes the safe signal, that may be sent via a wireless antenna (see e.g., 112 of FIG. 13). The sensed signal will block electrical signals to an affected machine control function (stage two). Here, in the second stage, the locking mechanism 3001, through mechanical closure, triggers a communication between the locking mechanism 3001 to a machine (not illustrated) that may be attached to or a controller (see e.g., 124 of FIG. 25) that may be interfaced with a machine or multiple machines or to a complete overall monitoring system. Additional aspects of the fall-protection system 3000 are discussed next with respect to FIG. 32.

FIG. 32 shows a fall-protection system 3000 within a larger overall safety system 3200 having additional safety and comfort features for a worker engaged in work using this system 3200 according to embodiments of the subject matter disclosed herein. The fall-protection system may be used in conjunction with several systems wherein the worker's environment can be monitored and enhanced. Thus, a worker 3205 may be engaged in work at a location requiring at least fall protection and may possibly be in an environment suited for additional enhanced functionality of the overall safety system 3200 of FIG. 32. Such functionality may take advantage of a smart safety vest 3206 worn by the worker 3205. The smart safety vest 3206 may engage with at least the fall protection system through a smart safety strap 3230 that includes an insert 16 suited to engage with the locking mechanism 3001. The smart safety vest 3206 may include a strap engagement anchor (not shown in FIG. 32—e.g., located on the back of the worker 3205) for engaging smart safety strap 3230. The smart safety vest 3206 then distributes forces exerted during a fall event around the torso of the worker 3205 such that no single body part bears the brunt of the falling force. In this manner, the worker is at least protected from falling hazards utilizing the fall-protection system 3000 as described with respect to FIGS. 30 and 31. Additionally, the worker 3205 may utilize additional functionality of the overall safety system 3200 as next described.

The overall safety system 3200 may include additional functionality for monitoring aspects of the worker 3205 or providing enhancements to the worker 3205. Each of these functions may be imparted through communications and/or supply cabling via the above-described signal cable 725/1325 of FIGS. 26 and 30. Thus, this signal cable, as described with respect to functionality below may include a collection of different types of cables, wiring, and/or tubing such that electrical signals and fluid transfer (e.g., air) may be realized. The individual cabling and tubing traces are not shown for ease of illustration. Furthermore, each remote sub-system within the overall safety system may utilize a communication and functionality aggregation device 3250 for assimilating and distributing signals and fluids to one or more workers. For example, the aggregation device 3250 may be mounted near the cable anchor 3014 such that electronic communications may be distributed between each subsystem and other workers anchored to the same cable anchor 3014.

A first sub-system 3270 for functionality provided to the worker 3205 may be a remote monitoring of vital statistics of the worker 3205 through a vital-statistics monitoring sub-system 3270. In this sub-system 3270, the worker 3205 may have a smart safety vest 3206 with sensors (not shown) suited to monitor different human statistics such as body temperature, heartrate, environment oxygen content, and the like. These sensors may provide electrical signals to the vital statistics monitoring sub-system 3270 such that any deviation from a normal range of operation condition may trigger an alarm that alerts the worker as well as additional personnel at the work location. Further, all vital statistics may be logged for review of any event that may have occurred while in operation.

A second sub-system 3275 for functionality provided to the worker 3205 may be a heating apparatus for the worker 3205 through a personal heating sub-system 3275. In this sub-system 3275, the worker 3205 may have a smart safety vest 3206 with heating elements (not shown) suited to impart heat to the worker 3205 in colder environments. These heating elements may be electrical radiation elements capable of giving off heat at safe levels around the torso of the worker 3205. The temperature of the imparted heat may be controlled locally by the worker 3205 or remotely by a system monitor.

A third sub-system 3280 for functionality provided to the worker 3205 may be a ventilation apparatus for the worker 3205 through a personal ventilation sub-system 3280. In this sub-system 3280, the worker 3205 may have a smart safety vest 3206 with cooling elements (not shown) suited to impart air conditioning to the worker 3205 in warmer environments. These cooling elements may be forced air outlets capable of forcing cool air toward and around the torso of the worker 3205. The temperature of the imparted air may be controlled locally by the worker 3205 or remotely by a system monitor.

A fourth sub-system 3285 for functionality provided to the worker 3205 may be enhanced communication the worker 3205 through a personal communication sub-system 3270. In this sub-system 3285, the worker 3205 may have a smart safety vest 3206 with audio speakers and a microphone (not shown) suited to facilitate two-way communication with a network of other communication devices. The audio speakers and microphone may utilize electrical or wireless communication signals via the personal communications sub-system 3285 such that any combination of communications signals may be realized. Further, all communication signals may be logged for review of any event that may have occurred while in operation.

It is to be understood that many changes in the particular structure, materials, and features described herein may be made without departing from the spirit and scope of the subject matter. Therefore, it is the Applicant's intention that its patent rights not be limited by the particular embodiments illustrated and described herein, but rather by the following claims interpreted according to accepted doctrines of claim interpretation, including the Doctrine of Equivalents and Reversal of Parts.

What is claimed is:

1. A fall-protection safety system, comprising:
an anchor apparatus configured to be anchored to a substantially immovable object;
a lead cable coupled to the ancho at a first end of the lead cable;
a locking device coupled a second end of the lead cable; and
a mechanical indicator disposed within to the locking device and away from the anchor apparatus, the indicator configured to indicate a fall event that exceeds a threshold force on the lead cable.

2. The fall-protection system of claim 1, wherein the mechanical indicator comprises a color that is chromatically different from the locking mechanism.

3. The fall-protection system of claim 1, wherein the mechanical indicator comprises a load pin configured to hold the mechanical indicator in a non-indication position if a fall event that exceeds the threshold has not occurred.

4. The fall-protection system of claim 1, wherein the mechanical indicator comprises a load pin configured to release the load indicator to an indication position if a fall event occurs that exceeds a threshold of 800 pounds of force on the lead cable.

5. The fall-protection system of claim 1, wherein the lead cable comprises braided steel having a tensile strength of at least 5000 pounds of force.

6. The fall-protection system of claim 1, wherein the substantially immovable object comprises a ceiling of a building in a manufacturing setting.

7. The fall-protection system of claim 1, wherein the locking device further comprises:
a receiver base having a plurality of locking mechanisms disposed therein and configured to securely engage an insert, at least one of the plurality of locking mechanisms including a locking indicator configured to indicate a signal on a signal channel that a respective locking mechanism is secured with the insert;
a linking member coupled to the receiver base, the linking member configured to link the locking mechanism with the lead cable; and
a signal wire coupled to the receiver base and configured to communicate the signal corresponding to the locking indicator.

8. The fall-protection system of claim 1, wherein the locking device further comprises:
a receiver base configured to securely engage an insert;
a pair of locking tabs configured to pivot about a respective pin operatively coupled to the receiver base, each locking tab having a first arm and a second arm; and
wherein each locking tab is spaced apart relative to the receiver base.

9. The fall-protection system of claim 8, wherein the receiver base further comprises an upper portion and a lower portion, and wherein a cavity configured to receive the insert is formed between the two locking tabs and the upper portion of the receiver base.

10. The fall-protection system of claim 1, wherein the locking device further comprises:
a receiver base having a plurality of locking mechanisms disposed therein and configured to securely engage an insert, at least one of the plurality of locking mechanisms including a locking indicator configured to indicate a signal on a signal channel that a respective locking mechanism is secured with the insert;
wherein the plurality of locking mechanisms comprises three locking mechanisms, each locking mechanism including a respective reed switch configured to indicate when the insert is secured with the respective locking mechanism; and
wherein each reed switch is communicatively coupled to the signal channel.

11. A fall-protection system locking device, comprising:
a receiver base configured to be coupled to a lead; and
a mechanical indicator disposed within the receiver base configured to mechanically indicate a fall event that exerts a force that exceeds a threshold force.

12. The locking device of claim 11, wherein the mechanical indicator comprises a color that is chromatically different from the receiver base.

13. The locking device of claim 11, wherein the mechanical indicator comprises a load pin configured to hold the mechanical indicator in a non-indication position if a fall event that exerts a force that exceeds the threshold has not occurred.

14. The locking device of claim 11, wherein the mechanical indicator comprises a load pin configured to release the load indicator to an indication position if a fall event occurs that exerts a force that exceeds a threshold of 800 pounds of force.

15. The locking device of claim 11, further comprising:
a plurality of locking mechanisms disposed within the receiver base and configured to securely engage an insert, at least one of the plurality of locking mechanisms including a locking indicator configured to indicate a signal that a respective locking mechanism is secured with the insert; and
a signal wire disposed within the receiver base and configured to communicate the signal corresponding to the locking indicator to a remote system.

16. The locking device of claim 11, further comprising:
a pair of locking tabs configured to pivot about a respective pin operatively coupled to the receiver base, each locking tab having a first arm and a second arm; and
wherein each locking tab is spaced apart relative to the receiver base.

17. The locking device of claim 16, wherein the receiver base further comprises an upper portion and a lower portion, and wherein a cavity configured to receive the insert is formed between the two locking tabs and the upper portion of the receiver base.

18. The locking device of claim 11, further comprising:
a plurality of locking mechanisms disposed within the receiver base and configured to securely engage an insert, at least one of the plurality of locking mechanisms including a locking indicator configured to indicate a signal on a signal channel that a respective locking mechanism is secured with the insert;
wherein the plurality of locking mechanisms comprises three locking mechanisms, each locking mechanism including a respective reed switch configured to indicate when the insert is secured with the respective locking mechanism; and
wherein each reed switch is communicatively coupled to the signal channel.
